(19) United States
(12) Patent Application Publication
(10) Pub. No.: US 2002/0138165 A1
(43) Pub. Date: Sep. 26, 2002

(54) System and method for recording and playing audio selections

(75) Inventors: William Palmer Lord, Fishkill, NY (US); Carolyn Christine Ramsey-Catan, Pleasantville, NY (US); Andrew Vincent Marolda, Ossining, NY (US)

Correspondence Address: Michael E. Marion, Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/817,091

(22) Filed: Mar. 26, 2001

(51) Int. Cl. G06F 17/00

(52) U.S. Cl. 700/94

(57) ABSTRACT

For use in an audio playback device capable of recording and playing audio selections, there is disclosed a system and method for recording and playing audio selections in response to user instructions. The system comprises an audio selection controller that is capable of receiving user instructions to record audio selections, identifying audio selections, and recording audio selections on a storage device. The system determines how many times an audio selection is authorized to be played. An audio selection that is not authorized to be played is deleted from the storage device or disabled from playing until an authorization to play the audio selection is received. The system is capable of responding to user instructions to increase or decrease the number of times a particular audio selection is to be played.

### TECHNICAL FIELD OF THE INVENTION

The present invention is directed, in general, to audio playback devices and, more specifically, to an audio playback device that is capable of recording and playing audio selections in response to the personal preferences of a user.

### BACKGROUND OF THE INVENTION

Audio playback devices are among the most popular consumer products created by the consumer electronics revolution. The term audio playback device is generally applied to any device that stores and plays back audio files in an electronic format. Analog audio playback devices are capable of recording and storing audio selections in analog form. Digital audio playback devices are capable of recording and storing audio selections in digital form.

Digital audio devices contain a large non-volatile memory, such as a hard disk drive or a flash random access memory (RAM), for storing audio selections in digital form. For example, one popular type of digital audio playback device contains a flash random access memory that stores sixty four (64) megabytes (MB) of music files in MP3 format. A user can record almost two hours of MP3 music files in sixty four (64) megabytes (MB) of memory. In addition, digital audio playback devices containing a hard disk drive may record up to twenty four (24) hours of music files on several gigabytes (GB) of disk space.

The number of audio selections available to be recorded is quite large. For example, some audio channels provided by cable television operators (or satellite television operators) supply as many as one hundred (100) channels of audio programming. From this wide array of audio channels a user can select the channel (or channels) that contains the type of music that the user likes best. However, the user has no control over the audio selections that are transmitted over the channel that the user has selected.

In order to allow customers to purchase an “individualized” compact disk of audio selections, some music vendors allow a customer to submit a list of desired audio selections. The music vendor will then record the list of audio selections on a compact disk and sell the compact disk to the customer. In this manner, the customer obtains a compact disk that contains the customer's desired audio selections.

Lastly, a user who desires to hear a particular audio selection can call in a request to a radio station to play the desired audio selection.

There is therefore a need in the art for a system and method that will allow a user to identify and record audio selections that the user prefers to hear. There is also a need in the art for a system and method that will allow a user to specify that certain recorded audio selections be played more often or less often. There is also a need in the art for a system and method that will allow a user to specify that certain audio selections never be recorded or played again. There is also a need in the art for a system and method that will allow a user to specify when certain recorded audio selections are to be played.

### SUMMARY OF THE INVENTION

To address the above-discussed deficiencies of the prior art, it is a primary object of the present invention to provide a system and method for recording and playing audio selections in response to user instructions that reflect the personal preferences of a user.

The system and method of the present invention comprises an audio playback device comprising an audio selection controller that is capable of identifying, recording, playing, and deleting individual audio selections as instructed by a user.

It is an object of the present invention to provide an audio playback device that is capable of identifying, recording, playing, and deleting individual audio selections such as music programs, talk shown programs, radio programs, audio book programs, and any other type of audio performance.

It is another object of the present invention to provide an audio playback device that is capable of allowing a user to specify how often the user wants to hear a recorded audio selection.

It is also an object of the present invention to provide an audio playback device that is capable of allowing a user to create a “personalized” set of recorded audio selections.

It is another object of the present invention to provide an audio playback device that is capable of determining how many times an audio selection is authorized to be played and that is capable of deleting a recorded audio selection if it is no longer authorized to be played.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” processor or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an exemplary digital audio system;

FIG. 2 illustrates a block diagram of an advantageous embodiment of an exemplary digital audio playback device comprising the system and method of the present invention;

FIG. 3 illustrates computer software that may be used in connection with the system and method of the present invention for recording and playing audio selections;

FIG. 4 depicts a flow diagram illustrating the operation of an advantageous embodiment of the method of the present invention in which an audio selection is recorded; and

FIG. 5 depicts a flow diagram illustrating the operation of an advantageous embodiment of the method of the present invention in which an audio selection is played.

### DETAILED DESCRIPTION OF THE INVENTION

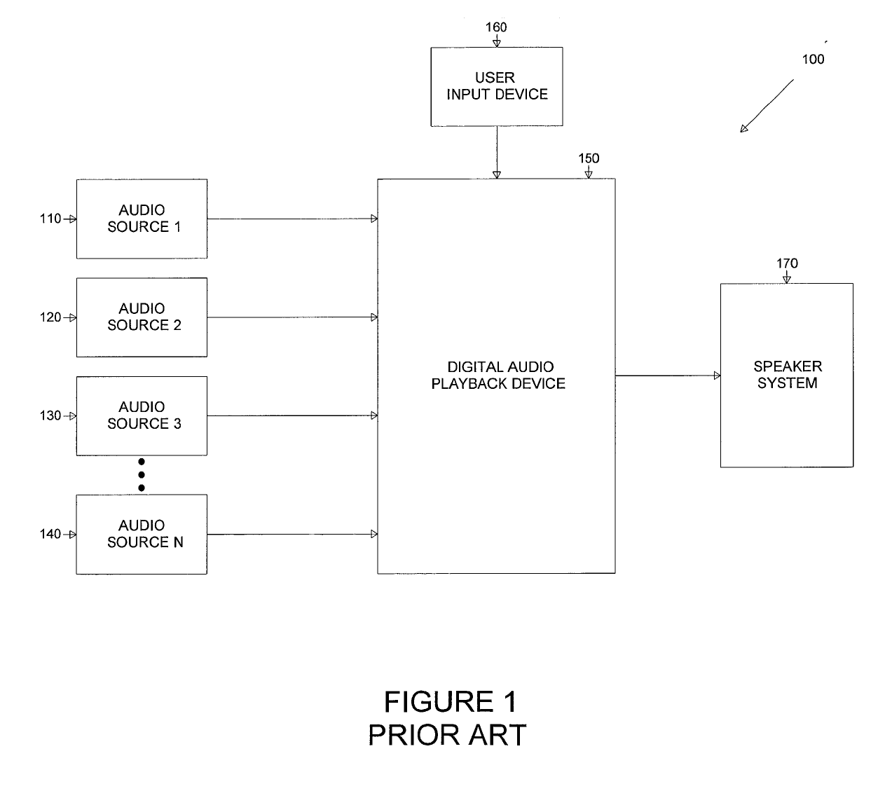

FIGS. 1 through 5, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, a digital audio system. Those skilled in the art will recognize that the exemplary embodiment of the present invention may easily be modified for use in any type of digital audio system or analog audio system.

FIG. 1 illustrates a block diagram of an exemplary embodiment of a digital audio system 100. Digital audio playback device 150 receives digital audio signals from each of a plurality of audio sources (110, 120, 130, . . . , 140). For example, audio source 1 (block 110) may provide a digital audio signal from a cable television service, while audio source 2 (block 120) provides a digital audio signal from an Internet radio station. At the same time, audio source 3 (block 130) may provide digital audio signals from a user's compact disk collection or from digital audio files stored on the user's personal computer. The ability of digital audio playback device 150 to receive digital audio signals from multiple sources is indicated in FIG. 1 by audio source N (block 140). That is, digital audio playback device 150 can receive digital audio signals from N audio sources, where N is an integer number.

The user may send instructions to digital audio playback device 150 with user input device 160. User input device 160 may comprise any one of a number of different types of conventional electronic input devices, including, without limitation, a keyboard, a remote control device, or a computer mouse (for digital audio playback devices that have a video use interface) The instructions that the user may input to digital audio playback device 150 will be discussed more fully below.

In response to user instructions, digital audio playback device 150 records audio selections. Also in response to user instructions, digital audio playback device 150 plays audio selections through speaker system 170. Speaker system 170 may comprise any one of a number of different types of conventional speaker systems.

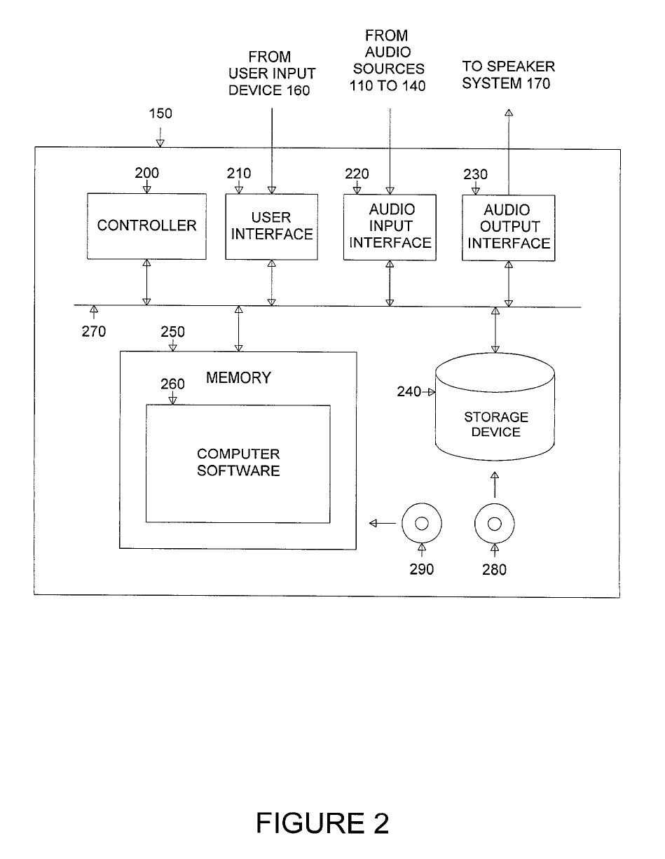

FIG. 2 illustrates a block diagram of exemplary digital audio playback device 150 shown in FIG. 1 according to an advantageous embodiment of the present invention. Exemplary digital audio playback device 150 comprises controller 200, user interface 210, audio input interface 220, and audio output interface 230. Exemplary digital audio playback device 150 also comprises a high capacity storage device 240, which may be, for example, a hard disk drive (HDD). Exemplary digital audio playback device 150 also comprises memory 250, which may be, for example, random access memory (RAM). As will be more fully discussed, memory 250 contains computer software 260 that may be used in connection with the system and method of the present invention. Controller 200, user interface 210, audio input interface 220, audio output interface 230, storage device 240 and memory 250 are coupled together by, and communicate through, communication bus 270.

In one advantageous embodiment of the present invention, audio input interface 220 of digital audio playback device 150 receives a digital audio signal from one of the audio sources (110, . . . , 140). Pursuant to instructions from controller 200, the digital audio signal may be sent via communications bus 270 to storage device 240. Storage device 240 then records the digital audio signal and the digital audio selection that is represents.

In an alternative advantageous embodiment, digital audio playback device 150 comprises an analog to digital converter (not shown) for converting analog audio signals into digital audio signals. This alternate embodiment of digital audio playback device 150 is capable of (1) receiving analog audio signals from an analog audio source, and (2) converting the analog audio signals into digital audio signals, and (3) storing the resulting digital audio signals in storage device 240.

Alternatively, also pursuant to instructions from controller 200, a digital audio signal may be sent via communications bus 270 to audio output interface 230 and to speaker system 170. Speaker system 170 then plays the digital audio signal and the digital audio selection that it represents. Audio digital playback device 150 is also capable of recording a digital audio signal on storage device 240 at the same time that the digital audio signal is being played on speaker system 170. Audio digital playback device 150 is also capable of recording a first digital audio signal on storage device 240 at the same time that a second digital audio signal previously stored on storage device 240 is being played on speaker system 170.

As previously mentioned, storage device 240 of digital audio playback device 150 may comprise a hard disk drive. In order to determine the size of hard disk drive required, one may consider that an ordinary compact disk contains approximately seventy four (74) minutes of audio content. The size of such a compact disk in megabytes of disk storage is approximately six hundred fifty megabytes (650 MB). This means that the streaming rate of compact disk quality sound is approximately 8.784 megabytes per minute. Therefore, to record twenty four (24) hours of audio content requires approximately 12.64 gigabytes (GB) of hard disk space. This requirement is well within the capability of many disk drives available on the market today.

In another advantageous embodiment, storage device 240 may comprise a solid state memory. In still another advantageous embodiments, storage device 250 may store and retrieve from a local read/write (R/W) digital versatile disk (DVD-RW) or a read/write (R/W) compact disk (CD-RW). Storage device 240 may be fixed (e.g., hard disk drive) or may be removable (e.g., DVD-RW, CD-RW).

For the purposes of this patent document and the claims that follow, storage device 240 is defined to include any mass storage device that is both readable and writable, including, but not limited to, conventional magnetic disk drives and optical disk drives for read/write digital versatile disks (DVD-RW), re-writable CD-ROMs, and the like. In fact, storage device 240 need not be fixed in the conventional sense that it is permanently embedded in digital audio playback device 150. Rather, storage device 240 includes any mass storage device that is dedicated to digital audio playback device 150 for the purpose of storing recorded audio selections. Thus, storage device 240 may include an attached peripheral drive or removable disk drives (whether embedded or attached), such as a juke box device (not shown) that holds several read/write DVDs or re-writable CD-ROMs. As illustrated schematically in FIG. 2, removable disk drives of this type are capable of receiving and reading re-writable CD-ROM disk 280.

Furthermore, in an advantageous embodiment of the present invention, storage device 240 may include external mass storage devices that digital audio playback device 150 may access and control via a network connection (e.g., Internet protocol (IP) connection), including, for example, a disk drive in the user's home personal computer (PC) or a disk drive on a server at the user's Internet service provider (ISP).

Digital audio playback device 150 comprises user interface 210 that is capable of receiving user instructions from user input device 160. As previously mentioned, user input device 160 may comprise a remote control device operated by the user. User interface 210 is also capable of receiving user instructions (such as Volume Up, Volume Down, Power On, Power Off) from user input device 160 to operate digital audio playback device 150. User instructions from user interface 210 may be sent to controller 200, to memory 250, or to storage device 240 via communication bus 270.

Controller 200 directs the overall operation of digital audio playback device 150, including the operation of functions such as Record mode, Play mode, Fast Forward (FF) mode, Reverse mode, and other similar functions. Controller 200 also directs the identification of audio selections, the recording of audio selections, the playing of audio selections, and deletion (or disabling) of audio selections in accordance with the principles of the present invention.

Controller 200 obtains information from audio input interface 220 concerning digital audio signals that are received by audio input interface 220. When controller 200 determines that digital audio playback device 150 is receiving an audio selection, controller 200 determines if the audio selection is one that has been selected to be recorded. If the audio selection is to be recorded, then controller 200 causes the audio selection to be recorded on storage device 240 in the manner previously described. If the audio selection is not to be recorded but is to be played, controller 200 then causes the audio selection to be processed by audio output interface 230 and sent to speaker system 170 in the manner previously described.

Memory 250 may comprise random access memory (RAM) or a combination of random access memory (RAM) and read only memory (ROM). Memory 250 may comprise a non-volatile random access memory (RAM), such as flash memory. In an alternate advantageous embodiment of digital audio playback device 150, memory 250 may comprise a mass storage data device, such as a hard disk drive (not shown). Memory 250 may also include an attached peripheral drive or removable disk drives (whether embedded or attached) that reads read/write DVDs or re-writable CD-ROMs. As illustrated schematically in FIG. 2, removable disk drives of this type are capable of receiving and reading re-writable CD-ROM disk 290.

An advantageous embodiment of the present invention comprises computer software 260 within memory 250. Computer software 260 operates in conjunction with controller 200 to provide a system and method for recording and playing digital audio selections in response to the personal preferences of a user. As will be more fully described, computer software 260 comprises computer software applications that are capable of executing user instructions to control the recording and playing of audio selections.

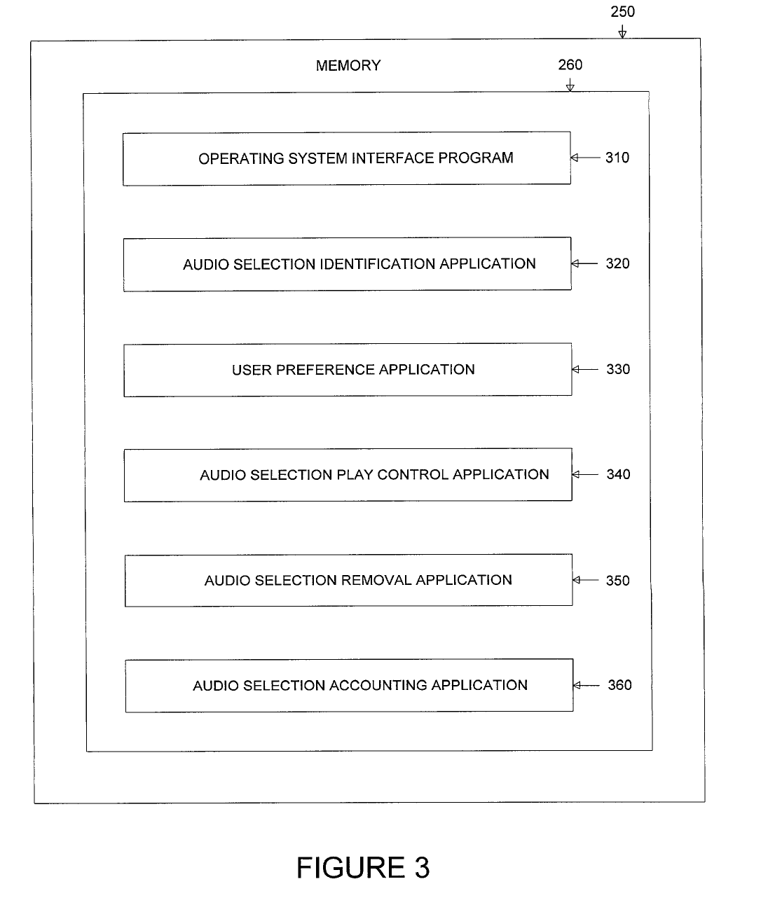

FIG. 3 illustrates a selected portion of memory 250 that contains computer software 260 of the present invention. Memory 250 contains operating system interface program 310, audio selection identification application 320, user preference application 330, audio selection play control application 340, audio selection removal application 350, and audio selection accounting application 360.

Controller 200 and computer software 260 together comprise an audio selection controller that is capable of carrying out the present invention. Operating system interface program 310 coordinates the operation of computer software 260 with the operating system of controller 200. Audio selection identification application 320 identifies individual audio segments as they are received in digital audio playback device 150.

Audio selection identification application 320 uses various methods to identify audio selections. Audio selections may be identified by finding identifying “tags” or “labels” in the incoming audio signal. Audio selections may also be identified by electronically consulting a “program guide” (i.e., a database) that contains information concerning the identity and time of transmission of individual audio selections. The identity of audio selections may also be determined by directly analyzing the audio signal (using “fingerprint” analysis or other similar techniques).

Controller 200 receives user instructions from user input device 160 (via user interface 210) to control the recording and playing of audio selections. In response to the user instructions, controller 200 is capable of executing the appropriate computer software application within computer software 260 to carry out the user instructions.

For example, the user may send an instruction to controller 200 indicating that the user desires digital audio playback device 150 to record the next audio selection to be played. The user sends the instruction to controller 200 via user input device 160 and user interface 210. In response to the instruction, controller 200 accesses user preference application 330 in software 260 stored within memory 250. User preference application 330 causes the selected audio selection to be recorded in storage device 240. User preference application 330 then causes the selected audio selection to be added to a list of user preferred audio selections. The list of user preferred audio selections is contained within user preference application 330.

For an additional example, the user may send an instruction to controller 200 indicating that the user desires a previously recorded audio selection to be played more often (or less often) when digital audio playback device 150 plays audio selections. The user sends the instruction to controller 200 via user input device 160 and user interface 210. In response to the instruction, controller 200 accesses audio selection play control application 340 in software 260 stored within memory 250. Audio selection play control application 340 causes the previously recorded audio selection to be played more often (or less often) in accordance with the user instruction. Specifically, audio selection play control application 340 increases (or decreases) the number of times that the audio selection is to be played. Audio selection play control application 340 causes the audio selection to be added to a list of audio selections that the user prefers to hear more often (or less often) in accordance with the user instruction.

The user may send an instruction to controller 200 indicating that the user desires a previously recorded audio selection to be deleted from storage device 240. The user sends the instruction to controller 200 via user input device 160 and user interface 210. In response to the instruction, controller 200 accesses audio selection removal application 350 in software 260 stored within memory 250. Audio selection removal application 350 causes the previously recorded audio selection to be deleted from storage device 240 in accordance with the user instruction.

The user can also give an instruction that a particular audio selection is not to be recorded. If the audio selection has already been recorded, then it is deleted from storage device 240 using audio selection removal application 350.

The user can also given an instruction that a particular audio selection is to be played at specified intervals. Audio selection play control application 340 causes the particular audio selection to be played at the specified intervals in accordance with the user instruction. Alternatively, the user can also given an instruction that the playing time for a particular audio selection is to be a specified percentage of the total playing time. Also alternatively, the user can give an instruction to set a time at which a particular audio selection is to be played. Audio selection play control application 340 is also capable of executing these types of user instructions.

Depending upon the nature of the user's rights to make copies of audio selections, a particular audio selection may have to be removed from storage device 240 as soon as the audio selection has been played. Audio selection accounting application 360 keeps track of how many times a particular audio selection may be played before it must be removed. When audio selection accounting application 360 determines that a particular audio selection must be removed, it sends a signal to controller 200. Controller 200 then sends a signal to audio selection removal application 350 to delete the audio selection from storage device 240.

Alternatively, audio selection accounting application 360 keeps track of how many times a particular audio selection may be played before the audio selection is no longer authorized to be played. When audio selection accounting application 360 determines that a particular audio selection is no longer authorized to be played, audio selection accounting application 360 prevents the audio selection from being played. The audio selection is not deleted from storage device 240. However, the audio selection can only be played when audio selection accounting application 360 receives a new authorization to play the audio selection. In this manner, audio selection accounting application 360 ensures that audio selections are played only when they are authorized to be played.

For example, audio selections from a cable television provider may be acquired by digital audio playback device 150. Each audio selection must be deleted (or disabled) after it has been played once. If authorization to play a particular audio selection has been acquired more times than the audio selection has been played by the user, then audio selection accounting application 360 keeps track of the number of times remaining that the audio selection may be played before it must be deleted (or disabled).

If the audio selections are from compact disks that are owned by the user, then audio selection accounting application 360 will not have to remove (or disable) the audio selections after they have been played by the user.

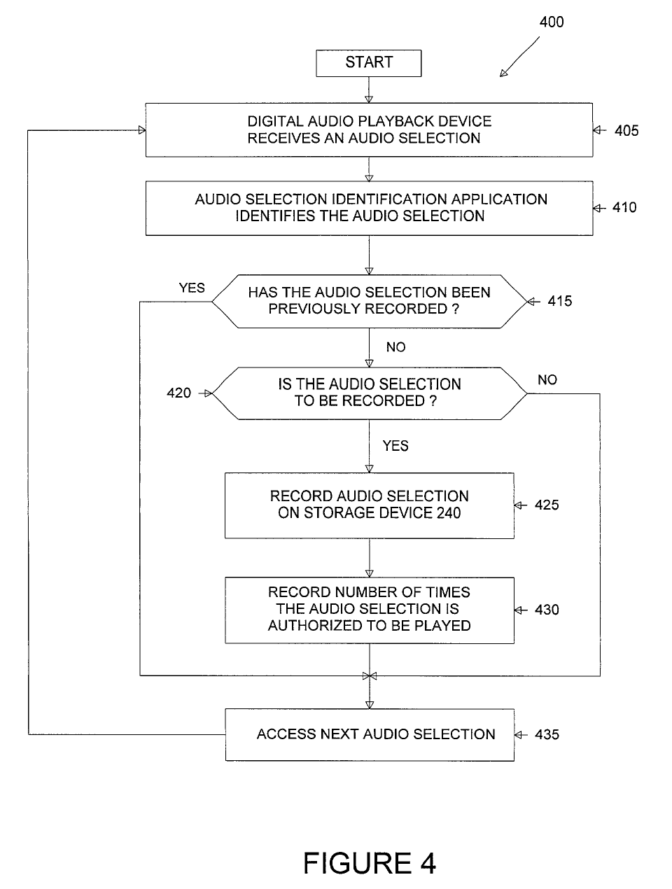

FIG. 4 depicts flow diagram 400 which illustrates the operation of exemplary digital audio playback device 150 in recording an audio selection according to one advantageous embodiment of the present invention. The steps set forth in flow diagram 400 are executed in digital audio playback device 150 and, more particularly, in the audio selection controller that comprises controller 200 and computer software 260.

Digital audio playback device 150 receives an audio selection (step 405). Audio selection identification application 320 then identifies the audio selection (step 410). Then a determination is made whether the audio selection has previously been recorded (decision step 415).

If the audio selection has previously been recorded, control passes to step 435 and the next audio selection is accessed. If the audio selection has not previously been recorded, then a determination is made whether the audio selection is to be recorded (decision step 420). If it is determined that the audio selection is to be recorded, the audio selection is recorded on storage device 240 (step 425). Then the number of times that the audio selection is authorized to be played is recorded in audio selection accounting application 360 (step 430). Then control passes to step 435 and the next audio selection is accessed. If it is determined in decision step 420 that the audio selection is not to be recorded, control passes to step 435. control passes from step 435 to step 405 and digital audio playback device 150 receives a new audio selection (step 405).

In an alternate embodiment of the method of the present invention, digital audio playback device 150 automatically changes to a new audio source if it is determined in decision step 420 that the current audio selection is not to be recorded. This step maximizes and effectively utilizes the recording time. In an advantageous embodiment of the present invention, the audio source to which digital audio playback device 150 automatically switches is an audio source that is the most likely to play audio selections in an audio category with the larges deficit of desired audio selections recorded on storage device 240.

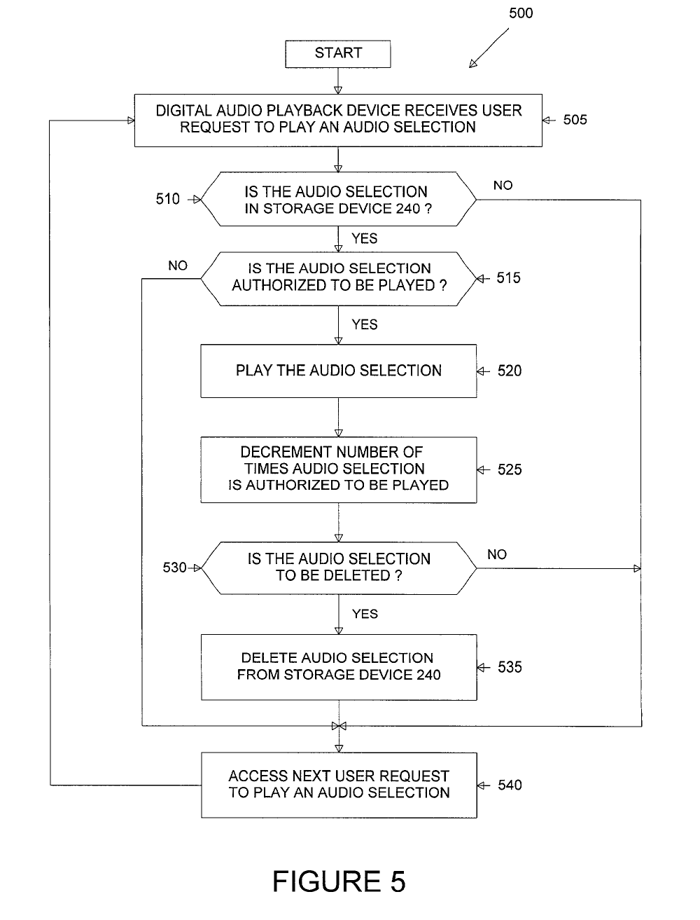

FIG. 5 depicts flow diagram 500 which illustrates the operation of exemplary digital audio playback device 150 in playing an audio selection according to one advantageous embodiment of the present invention. The steps set forth in flow diagram 500 are executed in digital audio playback device 150 and, more particularly, in the audio selection controller that comprises controller 200 and computer software 260.

Digital audio playback device 150 receives a user request to play an audio selection (step 505). A determination is then made whether the requested audio selection has previously been recorded in storage device 240 (decision step 510). If it is determined that the requested audio selection is not recorded in storage device 240, control passes to step 540 and the next user request is accessed. Control passes from step 540 to step 505 and digital audio playback device 150 receives the new user request to play an audio selection.

If it is determined that the requested audio selection is recorded in storage device 240, then audio selection accounting application 360 make a determination whether the requested audio selection is authorized to be played (decision step 515). If it is determined that the requested audio selection is not authorized to be played, control passes to step 540 and the next user request is accessed. If it is determined that the requested audio selection is authorized to be played, then the requested audio selection is played (step 520). After the requested audio selection has been played, the number of times the requested audio selection is authorized to be played is decremented (i.e., reduced by one) in audio selection accounting application 360 (step 525).

A determination is then made whether the requested audio selection that has just been played is to be deleted from storage device 240 (decision step 530). If it is determined that the requested audio selection is not to be deleted from storage device 240, then control passes to step 540 and the next user request is accessed. If it is determined that the requested audio selection is to be deleted from storage device 240, then audio selection removal application 350 deletes the audio selection from storage device 240 (step 535). Control passes to step 540 and the next user request is accessed.

The system and method of the present invention provides an improved digital audio playback device 150 that is capable of recording only audio selections that the user desires to hear. The audio selections may be music programs, talk shown programs, radio programs, audio book programs, and any other type of audio performance. The user can specify how often that he or she wants to hear a particular audio selection. The user may want to hear a particular audio selection more often, or less often, or never again. The user may also specify that a particular audio selection is only to be played at specified times (e.g., when entertaining guests). The present invention allows a user to create a “personalized” digital audio playback device that may be directly programmed by the user to record and play only the audio selections that the user desires.

One advantageous embodiment of the present invention comprises a digital audio playback device. It is understood, however, that the principles of the present invention may also be embodied in an analog playback device that is capable of receiving and recording analog audio selections.

Although the present invention has been described in detail, those skilled in the art should understand that they can make various changes, substitutions and alterations herein without departing from the spirit and scope of the invention in its broadest form.

What is claimed is:

1. For use in an audio playback device capable of recording and playing audio selections, a system for recording and playing audio selections in response to user instructions, said system comprising:
an audio selection controller capable of receiving a user instruction to record an audio selection, and capable of identifying said audio selection when said audio playback device receives said audio selection, and capable of recording said audio selection on a storage device.

2. The system as claimed in claim 1 wherein said audio selection controller is capable of determining whether said audio selection has previously been recorded on said storage device.

3. The system as claimed in claim 1 wherein said audio selection controller is capable of determining how many times said audio selection is authorized to be played.

4. The system as claimed in claim 1 wherein said audio selection controller comprises:
a controller capable of executing computer software instructions contained within a memory coupled to said controller (1) to receive said user instruction to record an audio selection, and (2) to identify said audio selection when said audio selection is received by said audio playback device, and (3) to record said audio selection on said storage device.

5. The system as claimed in claim 4 wherein said controller is capable of executing computer software instructions contained within a memory coupled to said controller to determine whether said audio selection has previously been recorded on said storage device.

6. The system as claimed in claim 4 wherein said controller is capable of executing:
an audio selection play control application capable of receiving said user instruction to record an audio selection;
an audio selection identification application capable of identifying said audio selection when said audio selection is received by said audio playback device; and
an audio selection accounting application capable of determining how many times said audio selection is authorized to be played.

7. The system as claimed in claim 1 wherein said audio selection controller is capable or receiving a user instruction to play an audio selection, and capable of determining whether said audio selection is authorized to be played, and capable of playing said audio selection if said audio selection is authorized to be played.

8. The system as claimed in claim 7 wherein said audio selection controller is capable of receiving a user instruction to increase the number of times said audio selection is to be played.

9. The system as claimed in claim 7 wherein said audio selection controller is capable of receiving a user instruction to decrease the number of times said audio selection is to be played.

10. The system as claimed in claim 7 wherein said audio selection controller is capable of receiving a user instruction to set at time at which said audio selection is to be played.

11. The system as claimed in claim 7 wherein said audio selection controller is capable of playing said audio selection at the same time that said audio selection is being recorded.

12. The system as claimed in claim 7 wherein said audio selection controller is capable of playing a first audio selection at the same time that a second audio selection is being recorded.

13. The system as claimed in claim 7 wherein said audio selection controller is capable of deleting said audio selection from said storage device when said audio selection is not authorized to be played.

14. The system as claimed in claim 7 wherein said audio selection controller is capable of disabling said audio selection on said storage device from being played when said audio selection is not authorized to be played.

15. The system as claimed in claim 14 wherein said audio selection controller is capable of enabling a disabled audio selection to be played after said audio selection controller receives at least one authorization for said audio selection to be played.

16. The system as claimed in claim 7 wherein said audio selection controller comprises a controller capable of executing computer software instructions contained within a memory coupled to said controller (1) to receive said user instruction to record an audio selection, and (2) to determine whether said audio selection is authorized to be played, and (3) to play said audio selection if said audio selection is authorized to be played.

17. A method for recording and playing audio selections on an audio playback device capable of recording and playing audio selections, said method comprising the steps of:
receiving a user instruction to record an audio selection;
identifying said audio selection when said audio playback device receives said audio selection; and
recording said audio selection on a storage device.

18. The method as claimed in claim 17 further comprising the steps of:
determining whether said audio selection has previously been recorded on said storage device; and
determining how many times said audio selection is authorized to be played.

19. The method as claimed in claim 18 further comprising the steps of:
increasing the number of times said audio selection is to be played in response to a user instruction; and
decreasing the number of times said audio selection is to be played in response to a user instruction.

20. The method as claimed in claim 18 further comprising the step of:
deleting said audio selection from said storage device when said audio selection is not authorized to be played.

21. The method as claimed in claim 18 further comprising the step of:
disabling said audio selection on said storage device from being played when said audio selection is not authorized to be played.

22. The method as claimed in claim 21 further comprising the steps of:
determining that a disabled audio selection has received at least one authorization to be played; and
enabling said disabled audio selection to be played.

23. For use in an audio playback device capable of recording and playing audio selections, computer-executable instructions stored on a computer-readable storage medium for recording and playing audio selections in response to user instructions, the computer-executable instructions comprising the steps of:
receiving a user instruction to record an audio selection;
identifying said audio selection when said audio playback device receives said audio selection; and
recording said audio selection on a storage device.

24. The computer-executable instructions stored on a computer-readable storage medium as claimed in claim 23 further comprising the steps of:
determining whether said audio selection has previously been recorded on said storage device; and
determining how many times said audio selection is authorized to be played.

25. The computer-executable instructions stored on a computer-readable storage medium as claimed in claim 24 further comprising the steps of:
increasing the number of times said audio selection is to be played in response to a user instruction; and
decreasing the number of times said audio selection is to be played in response to a user instruction.

26. The computer-executable instructions stored on a computer-readable storage medium as claimed in claim 24 further comprising the step of:
deleting said audio selection from said storage device when said audio selection is not authorized to be played.

27. The computer-executable instructions stored on a computer-readable storage medium as claimed in claim 24 further comprising the step of:
disabling said audio selection on said storage device from being played when said audio selection is not authorized to be played.

28. The computer-executable instructions stored on a computer-readable storage medium as claimed in claim 27 further comprising the steps of:
determining that a disabled audio selection has received at least one authorization to be played; and
enabling said disabled audio selection to be played.
